(19) United States
(12) Patent Application Publication
(10) Pub. No.: US 2011/0238188 A1
(43) Pub. Date: Sep. 29, 2011

(54) ENGINEERING TOOL

(75) Inventor: Mitsuhiro Washiro, Tokyo (JP)

(73) Assignee: YOKOGAWA ELECTRIC CORPORATION, Tokyo (JP)

(21) Appl. No.: 13/069,934

(22) Filed: Mar. 23, 2011

(30) Foreign Application Priority Data
Mar. 23, 2010 (JP) 2010-066286

(51) Int. Cl. G05B 11/01

(52) U.S. Cl. 700/19

(57) ABSTRACT

An engineering tool is provided with a first connector that connects to a first field device, a second connector that connects to a second field device, a controller, and, switch that switches the connection to the controller between the first connector and the second connector. Upon receiving instructions for transferring engineering information, the controller switches the switch to the first connector, acquires predetermined engineering information from the first field device, subsequently switches the switch to the second connector, and configures the second field device with the predetermined engineering information thus acquired.

### BACKGROUND OF THE DISCLOSURE

1. Field of the Disclosure

The present disclosure relates to an engineering tool. More particularly, the present disclosure relates to an engineering tool that simplifies the work of transferring engineering information when replacing a field device connected to a FOUNDATION™ fieldbus (hereinafter abbreviated to fieldbus).

2. Description of the Related Art

Plant control using a fieldbus has come to be widely used in recent years. As illustrated in FIG. 8, plant control using a fieldbus involves a plurality of field devices 20 (20a, 20b, etc.) connected to a fieldbus 30 installed in a plant. The field devices 20 communicate with each other, while additionally executing plant control while communicating via a distributed control system (DCS) 60 on an upper-layer control bus 50 and an interface 40.

The unit of signal processing in the field devices 20 is the function block, and each field device 20 is provided with at least one function block. Several types of function blocks exist, such as analog input (AI), analog output (AO), PID controller (PID), and device controller (DC) function blocks. In each function block, there are defined block parameters for configuring the operation of the function block.

With plant control using the fieldbus 30, required function blocks are joined together in software via link objects, and target control processes are executed as a result of the function blocks successively conducting processes.

In addition, the execution timings for the function blocks to be used are defined by execution scheduling objects. These objects are implemented as resources in each field device 20. Execution scheduling objects are also referred to as FOUNDATION fieldbus (FF) function block schedule objects.

Related art is disclosed in Japanese Unexamined Patent Application Publication No. 2005-158026, for example.

### SUMMARY OF THE DISCLOSURE

Meanwhile, with plant control using the fieldbus 30, a field device 20 might be replaced in some cases, because of a failure in the field device 20 or in order to introduce a new model, for example. When replacing a field device 20 connected to the fieldbus, it is necessary to transfer engineering information from the old field device to the new field device.

In the past, the work of transferring engineering information from an old field device to a new field device has involved the use of an engineering tool made up of a personal computer (PC) or similar information processing apparatus installed with engineering software, as well as a fieldbus interface. Such engineering tools are typically assembled by the user.

The work of transferring engineering information involves the following. The user brings an assembled engineering tool into the plant, and connects the engineering tool to the fieldbus. The user then operates the engineering software to read out and save engineering information from the old field device. Subsequently, the user disconnects the old field device from the fieldbus, and connects the new field device to the fieldbus. The user then selects the necessary information from among the saved engineering information, and writes the selected information to the new field device.

A prerequisite to the above work requires the node address of the new field device to be set in advance to the same address as the node address of the old field address when connecting the new field device to the fieldbus. When this is not the case, the user must create a separate fieldbus and carry out the above work on that fieldbus. In order to avoid such a situation, it is necessary to conduct an advance check of identification information such as the node address of the new field device.

Furthermore, there is also a problem in that the user must refer to manuals or other reference materials and selectively include or exclude specific engineering information to be transferred to the new field device. This process is troublesome and inconvenient for the user.

Moreover, in addition to the need to connect the engineering tool to the fieldbus, the following problem also exists. Since the engineering tool is assembled using a PC or similar information processing apparatus, it is extremely difficult to perform the work in adverse weather conditions or in hazardous areas.

Thus, the present disclosure provides an engineering tool that simplifies the work of transferring engineering information when replacing a field device connected to a fieldbus.

In order to solve the foregoing problems, an engineering tool in accordance with an embodiment of the present disclosure is provided with: a first connector that connects to a first field device; a second connector that connects to a second field device; a controller; and relay means that switches the connection to the controller between the first connector and the second connector. Upon receiving instructions for transferring engineering information, the controller switches the relay means to the first connector, and acquires predetermined engineering information from the first field device. Subsequently, the controller switches the relay means to the second connector, and configures the second field device with the predetermined engineering information thus acquired.

In an engineering tool in accordance with an embodiment of the present disclosure, if the user connects a first field device to the first connector and a second field device to the second connector, and issues instructions for transferring engineering information, then the necessary engineering information will be acquired from the first field device and set in the second field device. For this reason, the work of transferring engineering information when replacing a field device connected to a fieldbus can be simplified.

More specifically, the predetermined engineering information may be the node address of the first field device, link objects for device-internal computation, block parameters, and execution scheduling link objects.

Since other engineering information is set by the distributed control system when connecting the second field device to the fieldbus, transferring just the above information is sufficient.

Among the acquired engineering information, it is preferable for the controller to configure the second field device with the node address information first. This is because other information sometimes depends on the node address information being already set.

In addition, the connection with the first field device and the connection with the second field device may be established by means of a fieldbus interface.

According to an embodiment of the present disclosure, there is provided an engineering tool that simplifies the work of transferring engineering information when replacing a field device connected to a fieldbus.

### BRIEF DESCRIPTION OF THE DRAWINGS

FIG. 1 is a block diagram illustrating a configuration of an engineering tool in accordance with the present embodiment;

FIG. 2 is a flowchart explaining the processing operations of an I/O microcontroller in the case of receiving the operation of a copy start switch;

FIG. 3 is a flowchart explaining the processing operations of a main CPU board in the case of receiving a notification indicating that the copy start switch is on;

FIG. 4 is a flowchart explaining the processing operations of an I/O microcontroller in the case of receiving relay control instructions from a main CPU board;

FIG. 5 is a flowchart explaining the processing operations of a main CPU board in the case of receiving a relay switching complete notification from an I/O microcontroller after having issued instructions for switching to the old field device;

FIG. 6 is a flowchart explaining the processing operations of a main CPU board in the case of receiving a relay switching complete notification from an I/O microcontroller after having issued instructions for switching to the new field device;

FIG. 7 is a flowchart explaining the processing operations of an I/O microcontroller in the case of receiving output instructions from a main CPU board; and

FIG. 8 is a block diagram illustrating an exemplary configuration of plant control using fieldbus.

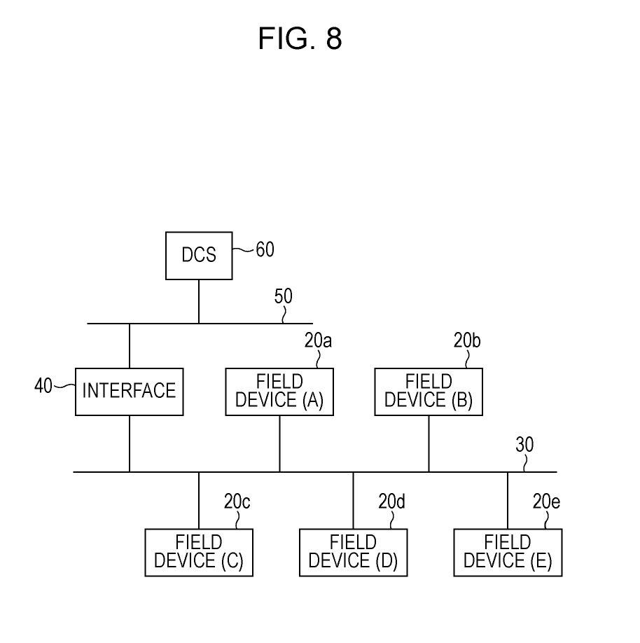

### DESCRIPTION OF SOME EMBODIMENTS

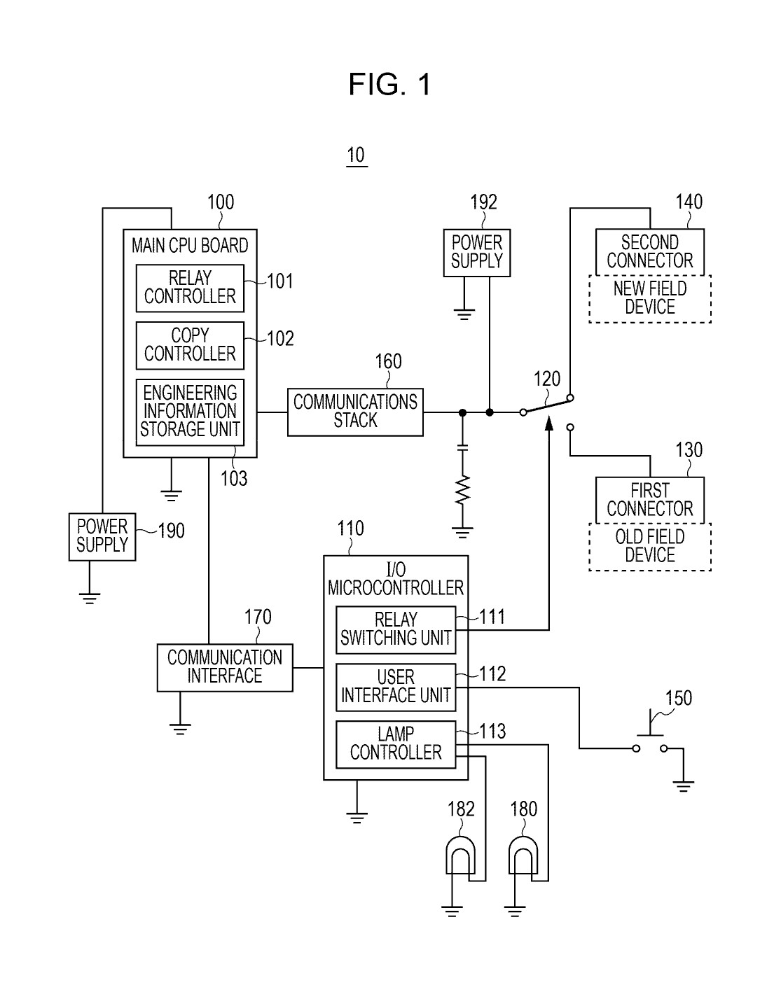

An embodiment of the present disclosure will now be described with reference to the drawings. FIG. 1 is a block diagram illustrating a configuration of an engineering tool in accordance with the present embodiment. As illustrated in FIG. 1, the engineering tool 10 is provided with a main CPU board 100, an I/O microcontroller 110, a relay 120, a first connector 130, a second connector 140, a copy start switch 150, a communications stack 160, a communication interface 170, a Done lamp 180, an Error lamp 182, a power supply 190, and a power supply 192.

The main CPU board 100 is provided with components such as a CPU and memory. The main CPU board 100 operates on power supplied from the power supply 190, and functions as a controller that controls various processes in the engineering tool 10.

The I/O microcontroller 110 controls input and output with respect to the engineering tool 10. The I/O microcontroller 110 is provided with the following: a relay switching unit 111, which switches the relay 120 according to instructions from the main CPU board 100; a user interface unit 112, which detects when the user operates the copy start switch 150; and a lamp controller 113, which controls the lighting of the Done lamp 180 and the Error lamp 182 according to instructions from the main CPU board 100.

The communications stack 160 is a module made up of a protocol group used by the fieldbus. In the present embodiment, a FOUNDATION Fieldbus™ having the specifications established by the Fieldbus Foundation is assumed. When a field device compliant with the protocol is connected to the first connector 130 or the second connector 140, the communications stack 160 communicates with the field device and creates a LiveList. A Livelist is a list indicating devices presently existing upon the bus. In the LiveList, the node addresses of recognized field devices, the ID's of recognized field devices, and the tags of recognized field device are registered. In addition, the main CPU board 100 is able to acquire arbitrary engineering information from a field device via the communications stack 160.

The communication interface 170 is a communication interface between the main CPU board 100 and the I/O microcontroller 110. In the present embodiment, the RS-232C serial communication standard is assumed.

The first connector 130 and the second connector 140 are connectors for connecting to the old field device and the new field device, respectively. Power required for the operation of the old field device and the new field device is supplied by the power supply 192. In other words, in the present embodiment, the old field device is removed from the fieldbus currently in operation and connected to the first connector 130. Meanwhile, the work of transferring engineering information is conducted with the new field device being connected to the second connector 140.

For this reason, it is not necessary to bring the engineering tool 10 into the plant and connect it to the fieldbus. Furthermore, it is not necessary to check the node address of the new field device in advance.

The relay 120 switches the target of communication with the main CPU board 100 between the old field device connected to the first connector 130, and the new field device connected to the second connector 140.

The copy start switch 150 is a switch that accepts work instructions for transferring engineering information from the user.

The Done lamp 180 is a lamp which indicates that the transfer of engineering information has been completed. The Error lamp 182 is a lamp which indicates that an error has occurred during the transfer of engineering information.

In the present embodiment, the main CPU board 100 is configured to include a relay controller 101, a copy controller 102, and an engineering information storage unit 103.

The relay controller 101 sends switching instructions for the relay 120 to the I/O microcontroller 110. More specifically, upon receiving a notification indicating that the user has operated the copy start switch 150, the relay controller 101 first sends instructions for switching the relay 120 to the first connector 130 connected to the old field device. Subsequently, once engineering information has been acquired from the old field device, the relay controller 101 sends instructions for switching the relay 120 to the second connector 140 connected to the new field device.

The copy controller 102 conducts a process for acquiring engineering information from the old field device, saving acquired engineering information in the engineering information storage unit 103, and configuring the new field device with the saved engineering information.

The engineering information storage unit 103 is a storage volume that stores engineering information acquired from the old field device. In the present embodiment, the engineering information stored in the engineering information storage unit 103 includes: the node address of the old field device, block parameters, link objects for device-internal computation, and execution scheduling objects. Herein, execution scheduling objects may also be referred to as FOUNDATION fieldbus (FF) function block schedule objects.

Next, processing operations of the above-configured engineering tool 10 will be described. Prior to the processing operations described hereinafter, the user removes an old field device from the fieldbus currently in operation, connects the old field device to the first connector 130, and connects a new field device to the second connector 140.

With the old field device and the new field device connected to the engineering tool 10, the user operates the copy start switch 150.

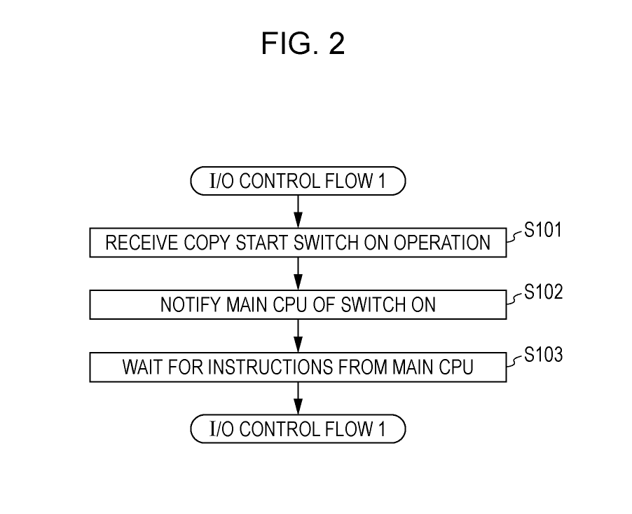

FIG. 2 is a flowchart explaining the processing operations of the I/O microcontroller 110 in the case of receiving the operation of the copy start switch 150.

Once the I/O microcontroller 110 receives the operation by the user to turn on the copy start switch 150 (S101), the user interface unit 112 activates, and issues a notification to the main CPU board 100 via the communication interface 170 indicating that the copy start switch 150 is on (S102). The I/O microcontroller 110 then waits for instructions from the main CPU board 100 (S103).

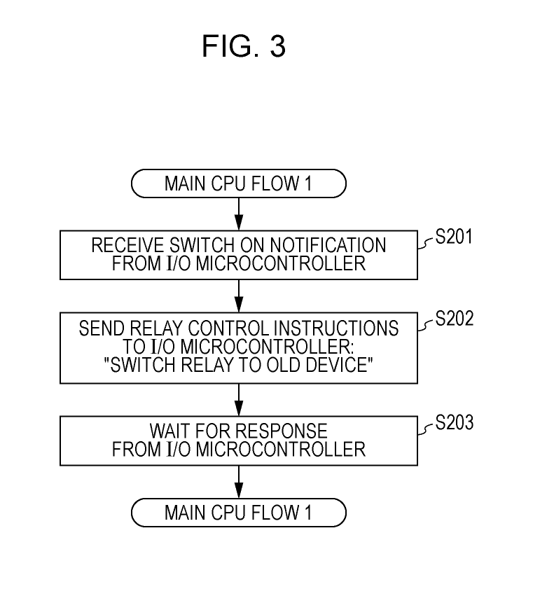

FIG. 3 is a flowchart explaining the processing operations of the main CPU board 100 in the case of receiving a notification from the I/O microcontroller 110 indicating that the copy start switch 150 is on.

Once the main CPU board 100 receives the notification from the I/O microcontroller 110 indicating that the copy start switch 150 is on (S201), the relay controller 101 activates, and sends relay control instructions to the I/O microcontroller 110 for switching the relay 120 to the old field device connected to the first connector 130 (S202). The main CPU board 100 then waits for a response from the I/O microcontroller 110 (S203).

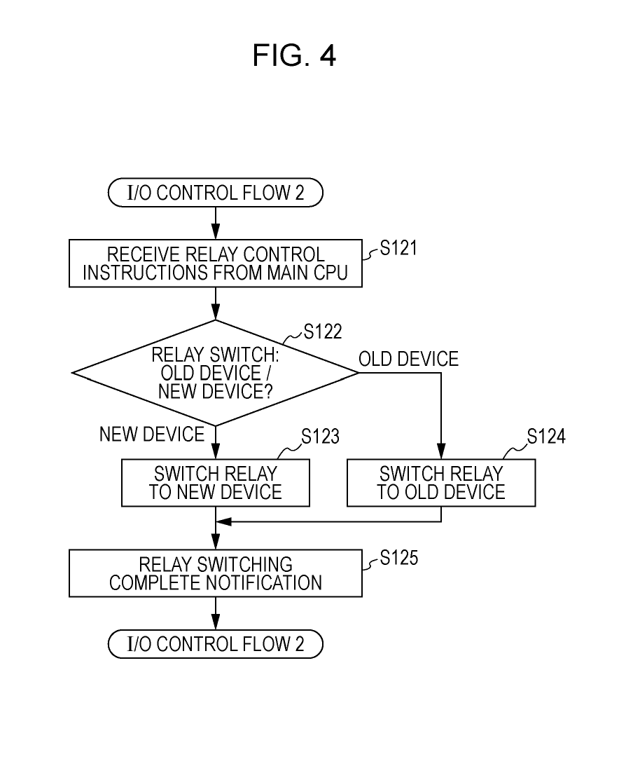

FIG. 4 is a flowchart explaining the processing operations of the I/O microcontroller 110 in the case of receiving relay control instructions from the main CPU board 100.

Once the I/O microcontroller 110 receives relay control instructions from the main CPU board 100 (S121), the relay switching unit 111 activates, and determines whether the received relay control instructions are relay control instructions for switching to the old field device connected to the first connector 130, or relay control instructions for switching to the new field device connected to the second connector 140 (S122).

As a result, in the case where the instructions are for switching to the old field device, the relay switching unit 111 switches the relay 120 to the old field device connected to the first connector 130 (S123).

In contrast, in the case where the instructions are for switching to the new field device, the relay switching unit 111 switches the relay 120 to the new field device connected to the second connector 140 (S124).

Upon switching the relay 120, a relay switching complete notification is sent to the main CPU board 100 (S125).

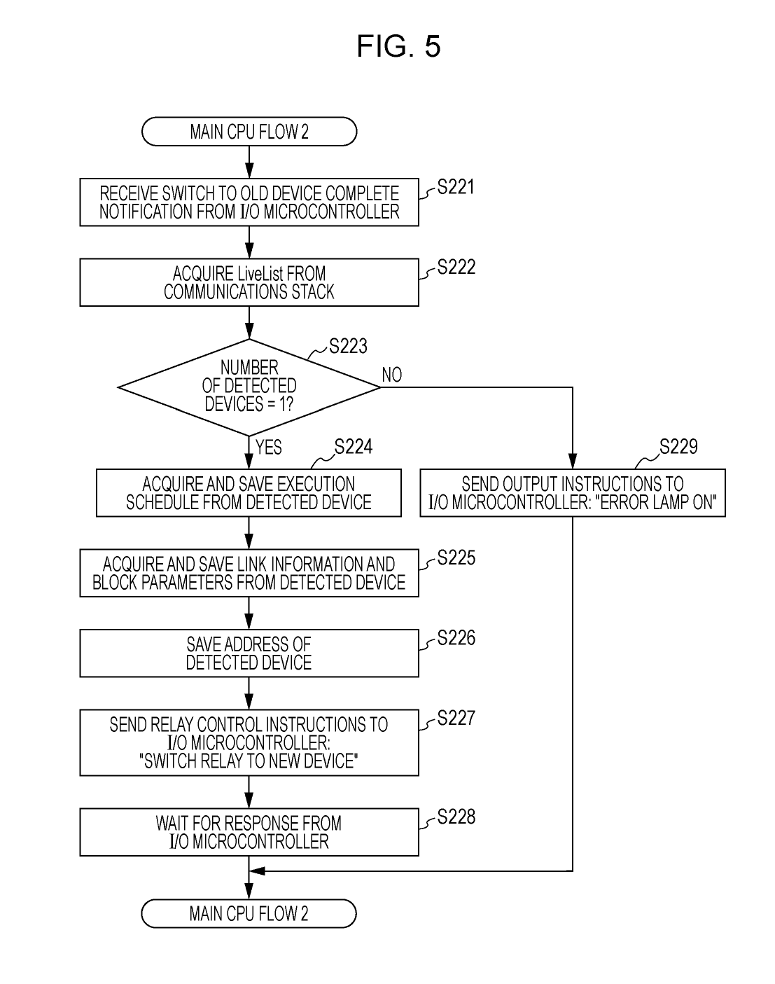

FIG. 5 is a flowchart explaining the processing operations of the main CPU board 100 in the case of receiving a relay switching complete notification from the I/O microcontroller 110 after having issued instructions for switching to the old field device.

Once the main CPU board 100 receives a relay switching complete notification from the I/O microcontroller 110 after having issued instructions for switching to the old field device (S221), the copy controller 102 activates, and acquires the LiveList of field devices connected to the first connector 130 from the communications stack 160 (S222). The LiveList contains the node address information of connected field devices.

If the number of field devices detected with the LiveList is one, or in other words, if only the old field device is detected (S223: Yes), then the engineering information acquisition process in operation 5224 and thereafter is conducted.

In contrast, if the number of field devices detected with the LiveList is other than one, such as when field devices cannot be recognized, for example (S223: No), then it is assumed that an error has occurred, and output instructions for turning on the Error lamp are sent to the I/O microcontroller 110 (S229). The present process is then terminated.

If the old field device is detected normally (S223: Yes), then the execution scheduling objects are acquired from the old field device thus detected, and the acquired execution scheduling objects are saved in the engineering information storage unit 103 (S224). More specifically, in the case of a FOUNDATION fieldbus, the FB₁₃START₁₃ENTRY and VCR₁₃ STATIC₁₃ ENTRY from the MIB-VFD are acquired and saved.

In addition, block parameters and link objects (i.e., information regarding links between device-internal function blocks) are acquired from the old field device thus detected, and are saved in the engineering information storage unit 103 (S225). More specifically, in the case of a FOUNDATION fieldbus, Link Objects from the FB-VFD and all parameters are acquired and saved.

Furthermore, the node address information of the old field device obtained from the acquired LiveList is saved in the engineering information storage unit 103 (S226). However, it should be appreciated that the order in which the above engineering information is saved is arbitrary.

In this way, in the present embodiment, the following information is sufficient as the engineering information to be transferred: node address information, link objects for device-internal computation, block parameters, and execution scheduling objects. Only the above information is acquired from the old field device and saved. For this reason, the user does not need to selectively include or exclude specific engineering information to be transferred.

Subsequently, the main CPU board 100 sends relay control instructions to the I/O microcontroller 110 for switching the relay 120 to the new field device connected to the second connector 140 (S227). The main CPU board 100 then waits for a response from the I/O microcontroller 110 (S228).

The processing operations of the I/O microcontroller 110 in the case of receiving relay control instructions from the main CPU board 100 for switching the relay 120 to the new field device connected to the second connector 140 are the same as those described using FIG. 4.

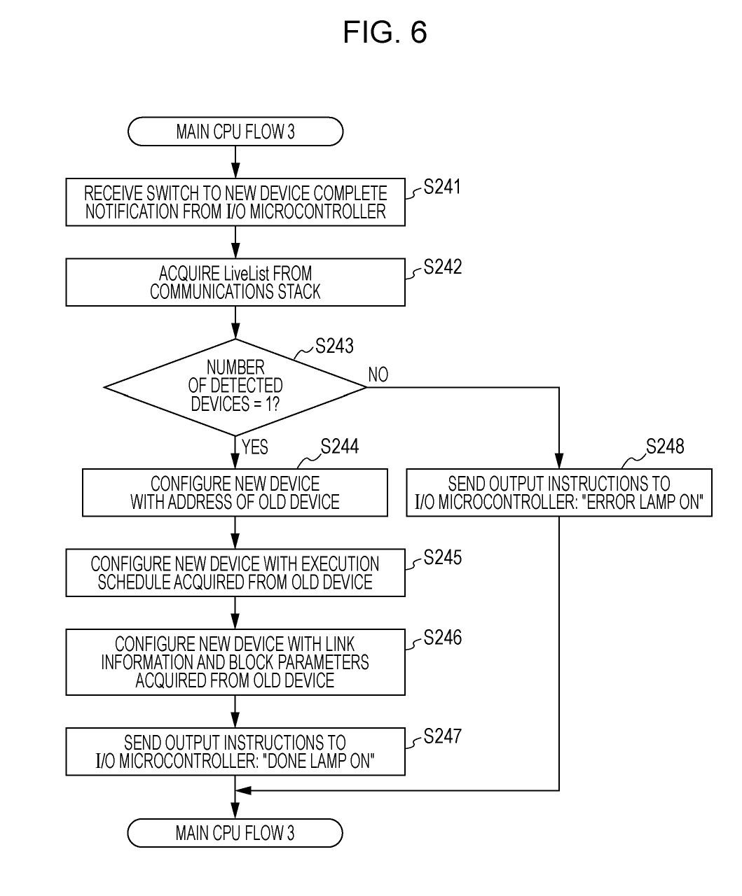

FIG. 6 is a flowchart explaining the processing operations of the main CPU board 100 in the case of receiving a relay switching complete notification from the I/O microcontroller 110 after having issued instructions for switching to the new field device.

Once the main CPU board 100 receives a relay switching complete notification from the I/O microcontroller 110 after having issued instructions for switching to the new field device (S241), the copy controller 102 activates, and acquires the LiveList of field devices connected to the second connector 140 from the communications stack 160 (S242). The LiveList contains the node address information of connected field devices.

If the number of field devices detected with the LiveList is one, or in other words, if only the new field device is detected (S243: Yes), then the engineering information setting process in operation S244 and thereafter is conducted.

In contrast, if the number of field devices detected with the LiveList is other than one, such as when field devices cannot be recognized, for example (S243: No), then it is assumed that an error has occurred, and output instructions for turning on the Error lamp are sent to the I/O microcontroller 110 (S248). The present process is then terminated.

If the new field device is detected normally (S243: Yes), then the main CPU board 100 configures the detected new field device with the node address of the old field device that is saved in the engineering information storage unit 103 (S244). The node address is set first because other engineering information sometimes depends on the node address information being already set.

The main CPU board 100 then configures the detected new field device with the execution scheduling objects that were acquired from the old field device and which are saved in the engineering information storage unit 103 (S245). More specifically, in the case of a FOUNDATION fieldbus, the FB₁₃ START₁₃ ENTRY and VCR_STATIC_ENTRY from the MIB-VFD are written to the new field device.

In addition, the main CPU board 100 configures the detected new field device with the device-internal link objects and block parameters that were acquired from the old field device and which are saved in the engineering information storage unit 103 (S246). More specifically, in the case of a FOUNDATION fieldbus, Link Objects from the FB-VFD and all saved parameters are written to the new field device.

Subsequently, the main CPU board 100 sends output instructions for turning on the Done lamp to the I/O microcontroller 110 (S247). The present process is then terminated.

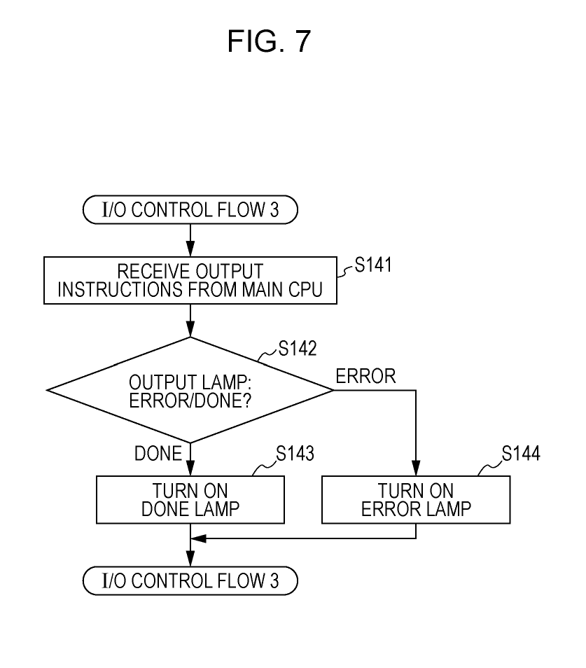

FIG. 7 is a flowchart explaining the processing operations of the I/O microcontroller 110 in the case of receiving output instructions from the main CPU board 100.

Once the I/O microcontroller 110 receives output instructions from the main CPU board 100 (S141), the lamp controller 113 activates, and determines whether the received output instructions are output instructions for turning on the Done lamp, or output instructions for turning on the Error lamp (S142).

As a result, in the case where the output instructions are for turning on the Done lamp, the I/O microcontroller 110 turns on the Done lamp 180 (S143). In contrast, in the case where the output instructions are for turning on the Error lamp, the I/O microcontroller 110 turns on the Error lamp 182 (S144).

By means of the foregoing processing sequences, necessary engineering information is transferred from the old field device to the new field device. The user then merely connects the new field device set with the necessary engineering information to the fieldbus currently in operation.

Herein, the engineering information that was not targeted for transfer may be reconstructed by the DCS or similar plant control system when the new field device is connected to the fieldbus currently in operation, and operation of the new field device may be initiated. Consequently, the following information is sufficient as the engineering information targeted for transfer: node address information, link objects for device-internal computation, block parameters, and execution scheduling objects.

As described in the foregoing, according to an engineering tool 10 in accordance with the present embodiment, it is sufficient for the user to connect an old field device and a new field device to the engineering tool 10 and operate the copy start switch 150. For this reason, the work of transferring engineering information when replacing a field device connected to a fieldbus is simplified. As a result, the precision of the replacement work is increased, and the work time is significantly reduced.

Furthermore, since the engineering tool 10 in accordance with the present embodiment does not need to be connected to the fieldbus currently in operation, it is not necessary to expose the fieldbus for maintenance. Moreover, since the engineering tool 10 in accordance with the present embodiment is simply constructed, the engineering tool 10 is easily adaptable to adverse weather conditions, hazardous areas, or other conditions.

It should also be appreciated that the engineering tool 10 in accordance with the present embodiment may also be utilized as component software constituting part of configuration and maintenance software executed on a PC or similar information processing apparatus.

In addition, the engineering tool 10 in accordance with the present embodiment may also be provided with an LCD or similar display apparatus, and additionally include functions enabling the user to edit some parameters during the transfer of engineering information, like a handheld terminal. Since existing handheld terminals are already provided with a main CPU board and a communications stack, an embodiment of the present disclosure can be easily applied to such handheld terminals.

In the foregoing embodiment, a FOUNDATION fieldbus is assumed as the fieldbus protocol. In other words, device description (DD) files stating information such as device-internal parameters are not required, and the respective processing operations of the main CPU board 100 can be realized as a control program shared by all devices, and based on FOUNDATION fieldbus specifications.

On the other hand, in the case of creating compatibility with other protocols such as HART, PROFIBUS, and BRAIN, the control bus can be made compatible by replacing components such as the communications stack 160 with one or more interface circuits compliant with each protocol. In addition, device-internal parameters and other control information to be copied may be distributed as a software component standardized for each protocol by the individual device vendors. For example, HART uses DDs, while PROFIBUS and BRAIN use device type managers (DTMs).

Such software components may be utilized by adopting a non-incendive PDA equipped with a general-purpose operating system compliant with Component Object Model (COM), and replacing the main CPU board with the non-incendive PDA.

What is claimed is:

1. An engineering tool, comprising:
a first connector that connects to a first field device;
a second connector that connects to a second field device;
a controller; and
a switch that switches the connection to the controller between the first connector and the second connector; wherein
upon receiving instructions for transferring engineering information, the controller commands the switch to connect to the first connector, acquires predetermined engineering information from the first field device, then subsequently commands the switch to connect to the second connector, and configures the second field device with the predetermined engineering information thus acquired.

2. The engineering tool according to claim 1, wherein
the predetermined engineering information is the node address information of the first field device, link objects for device-internal computation, block parameters, and execution scheduling objects.

3. The engineering tool according to claim 2, wherein
among the acquired engineering information, the controller configures the second field device with the node address information first.

4. The engineering tool according to claim 1, wherein
the connection with the first field device and the connection with the second field device are conducted by means of a fieldbus interface.

5. The engineering tool according to claim 2, wherein
the connection with the first field device and the connection with the second field device are conducted by means of a fieldbus interface.

6. The engineering tool according to claim 3, wherein
the connection with the first field device and the connection with the second field device are conducted by means of a fieldbus interface.
